(19) United States
(12) Patent Application Publication
(10) Pub. No.: US 2006/0241990 A1
(43) Pub. Date: Oct. 26, 2006

(54) Transportation planning with multi-level pooling model

(75) Inventors: Rongming Sun, Hayward, CA (US); Mukundan Srinivasan, Foster City, CA (US); Vinay Muralidhara Yadappanavar, San Mateo, CA (US)

Correspondence Address: MCDONALD HOPKINS CO., LPA, 600 SUPERIOR AVE., E., SUITE 2100, CLEVELAND, OH, 44114, US

(73) Assignee: Oracle International Corporation, REDWOOD SHORES, CA (US)

(21) Appl. No.: 11/113,514

(22) Filed: Apr. 25, 2005

(51) Int. Cl. G06F 9/46

(52) U.S. Cl. 705/8

(57) ABSTRACT

Systems, methodologies, media, and other embodiments associated with multi-level pooling in transportation planning are described. One exemplary method embodiment includes, co-operatively and in parallel choosing pooling points and order-legs to consolidate. The example method may also include constructing a cost-optimal trip based, at least in part, on the contemporaneously chosen pooling points and orders-legs.

### CROSS REFERENCE TO RELATED APPLICATIONS

This application is related to the following U.S. patent applications, which are all assigned to the present assignee, and which are incorporated herein by reference in their entirety:

“Transportation Planning With System Assisted Exception Resolution”, Ser. No. 11/093,830 filed Mar. 30, 2005, inventors: Goossens et al., attorney docket number 27252-26 (OID-2004-191-01);

“Transportation Planning With Multi-Level Firming”, Ser. No. 11/078,675 filed Mar. 11, 2005, inventors: Peterkofsky et al., attorney docket number 27252-27 (OID-2004-192-01);

“Transportation Planning With Parallel Optimization”, Ser. No. 11/097,435 filed Apr. 1, 2005, inventors Sun et al., attorney docket number 27252-28 (OID-2004-193-01);

“Optimization of Carrier Selection For Transportation Planning System”, Serial number unknown, filed Apr. 25, 2005, inventors Yadappanavar et al., attorney docket number 27252-30 (OID-2004-195-01); and

“Transportation Planning With Drop Trailer Arrangements”, Ser. No. 11/067,154, filed Feb. 25, 2005, inventors Peterkofsky et al., attorney docket number 27252-31 (OID-2004-196-01).

### BACKGROUND

Transportation planning concerns determining cost optimal solutions for transporting a set of orders from a set of origins to a set of destinations. Transportation planning may occur in an environment that includes a transportation network on which different carriers, modes, services, and equipment are available for transporting the subject matter of the orders. The environment may also include a rating structure for transportation services that depends on carriers, carriage modes, services, equipment dimensions, and so on. The environment may also include flexible and/or hard time window constraints concerning when orders are to be picked up and/or delivered, when facilities are open for service, pickup, drop-off, and so on. The environment may also include flexible and/or hard constraints concerning compatibilities. Thus, the environment in which transportation planning decisions are made can be quite complex, which in turn leads to difficulties with computing cost optimal solutions in meaningful time frames.

Conventional pooling decision tools are typically intractable, performance intensive, and do not scale well. Thus, these conventional pooling decision tools tend to create large bottlenecks in transportation planning systems. Conventional solutions may make local improvements for trips that were built after pooling points were pre-selected. The local improvements may involve incrementally adding orders to trips. However, these conventional systems may not capture the global picture of how things are flowing in the transportation network and may miss out on opportunities for cost improvements attributable to consolidation.

### BRIEF DESCRIPTION OF THE DRAWINGS

The accompanying drawings, which are incorporated in and constitute a part of the specification, illustrate various example systems, methods, and so on that illustrate various example embodiments of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Of course, embodiments and/or elements can be combined with other embodiments to produce variations of the systems and methods, and their equivalents.

FIG. 1 illustrates an example transportation planning method that employs network flow based multi-level pooling.

FIG. 2 illustrates an example transportation planning method that employs network flow based multi-level pooling.

FIG. 3 illustrates an example system associated with transportation planning using network flow based multi-level pooling.

FIG. 4 illustrates an example system associated with transportation planning using network flow based multi-level pooling.

FIG. 5 illustrates an example computing environment in which example systems and methods illustrated herein can operate.

FIG. 6 illustrates an example application programming interface (API).

FIG. 7 illustrates concepts associated with consolidation.

FIG. 8 also illustrates concepts associated with consolidation.

### DETAILED DESCRIPTION

Example systems and methods employ a network flow model to facilitate making transportation planning decisions associated with multi-level pooling. Multi-level pooling concerns situations where there may be more than one pooling point (e.g., consolidation point, deconsolidation point, cross-docking point) in a path from a source to a destination. Example systems and methods may establish and maintain a coupling between decisions concerning selecting pooling points and decisions concerning selecting order-legs to consolidate. These decisions may be based, for example, on a complete global picture of flow in a transportation network as captured by a mixed integer network flow model.

In one example, network flow model based solutions described herein may be global optimal when they attempt to exploit advantages offered by generating line-haul truckloads and thus consider a problem space that includes an entire set of orders and an entire set of candidate pooling points through which the orders may pass. These solutions may facilitate modeling complex consolidation advantages through the coefficients of objective functions employed in mixed integer network flow models. For example, the models may facilitate estimating cost-savings due to multi-stop trips that accommodate remainder flows that are not covered by consolidated loads and/or direct truckload loads. Thus, one example solution to a multi-level pooling problem considers all the possible paths through a transportation network and models the non-linear advantages of consolidation between air, parcel, and less-than-truckload carrier to allow for all feasible aggregations of order-legs into arc flows.

Example solutions may break orders into multiple order-legs between nodes in a transportation network and then model flows between the nodes. Based on the modeling, which order-legs to consolidate and which pooling points to use for (de)consolidating orders in the transportation network can be selected substantially simultaneously by co-operating processes. Unlike conventional systems, trip building may be delayed until after the coupled decisions concerning selecting pooling points and order-legs to consolidate are made. Furthermore, early commitment to certain pooling points and/or pre-selecting pooling points is not required, but may, in some examples, be user-configured.

As described above, transportation planning generally concerns determining how and when to ship items from sources to destinations. As used herein, transportation planning also refers to computer-based determining of how to interact with carriers who will be tasked with shipping items using vehicles like trucks. While trucks are described, it is to be appreciated that example systems and methods may facilitate planning for interacting with carriers that use other vehicles like trains, planes, and so on. Also, in some examples, “carriers” may include not only external transportation providers but also equipment owned, managed, and/or operated by the planning organization, and/or by other units of the same corporate, governmental, or other entity. Transportation planning may include planning actions and execution actions.

Unique elements of the North American regional transportation system lead to extensive truck utilization. The unique elements include long distances between major cities, an extensive high quality, government subsidized road network, relatively low fuel costs, a highly organized and competitive trucking industry, comparatively poor rail service over a relatively limited rail network, and a high level of economic activity over very dense traffic lanes. Thus, systems and methods that participate in truck based transportation planning may facilitate mitigating some inefficiencies associated with truck utilization by coupling decisions associated with selecting and employing pooling points, selecting and employing cross-docking points, and determining through which pooling points or cross-docking points consolidated order-legs will flow.

A transportation management system may include components like a planning component and an execution component. The planning component may perform tasks like breaking orders into order-legs, selecting pooling points, selecting order-legs to consolidate and so on. The results of these tasks may be recorded, for example, in an actionable plan of loads. The actionable plan of loads may be communicated to the execution component. The execution component may then perform tasks like rating, tendering, booking, tracing/tracking, and so on.

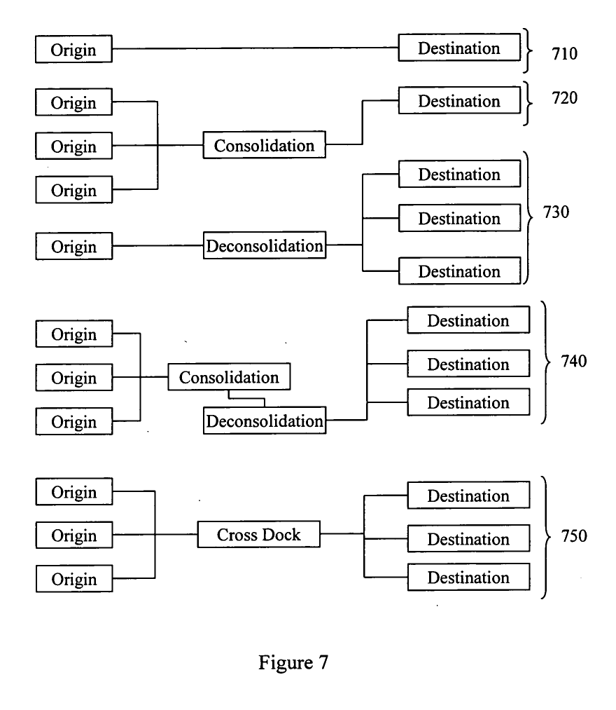

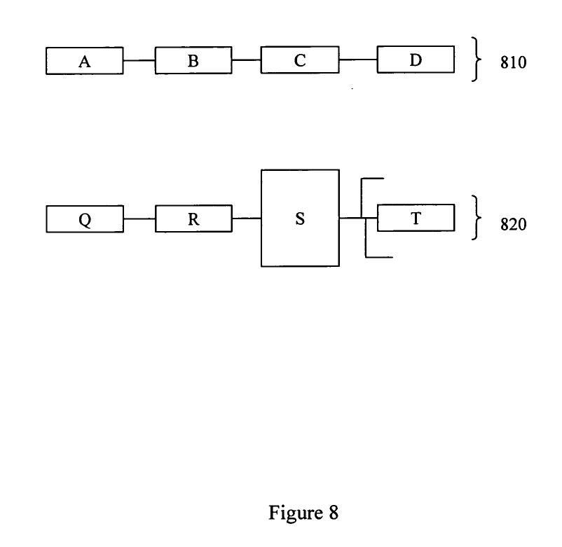

Example transportation management systems may include advanced consolidation strategies for exploiting economies of scale in transportation costs. One type of consolidation is referred to as hubbing. A hub is an intermediate facility that may be visited by orders flowing from an origin to a destination. There are different types of hubbing. For example, FIGS. 7 and 8 illustrate simple consolidation, simple deconsolidation, cross-docking, multi-level pooling, and so on.

The following includes definitions of selected terms employed herein. The definitions include various examples and/or forms of components that fall within the scope of a term and that may be used for implementation. The examples are not intended to be limiting. Both singular and plural forms of terms may be within the definitions even when only a singular term is used.

In the context of transportation planning and this application, “load” refers to a set of shipments assigned to a vehicle and assigned a schedule for delivery. A load may refer to a single stop load, a multi-stop load, and the like.

“Heuristic”, as used herein, refers to programming based on rules (e.g., “common sense” rules) that may, for example, be drawn from experience. Heuristics contrast with algorithmic programs that are based on mathematically provable procedures. In some examples, heuristics may include rules that are adaptable by self-learning.

As used in this application, the term “computer component”refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer communication” or “network communication”, as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate signals, instructions, data, or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device like a field programmable gate array (FPGA), a memory device containing instructions, combinations of logic devices, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. In the context of a network connection, an operable connection may be created though one or more computing devices and network components. Logical and/or physical communication channels can be used to create an operable connection.

“Signal”, as used herein, includes but is not limited to one or more electrical or optical signals, analog or digital signals, a bit or bit stream, and/or other means that can be received, transmitted and/or detected. A signal can also take other forms such as data, one or more computer or processor instructions, messages, and the like.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of methods, algorithms, and/or symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, intercepting, storing, redirecting, detecting, determining, displaying, or the like, refer to actions and processes of a computer system, logic, processor, or similar electronic device that manipulates and/or transforms data represented as physical (electronic) quantities.

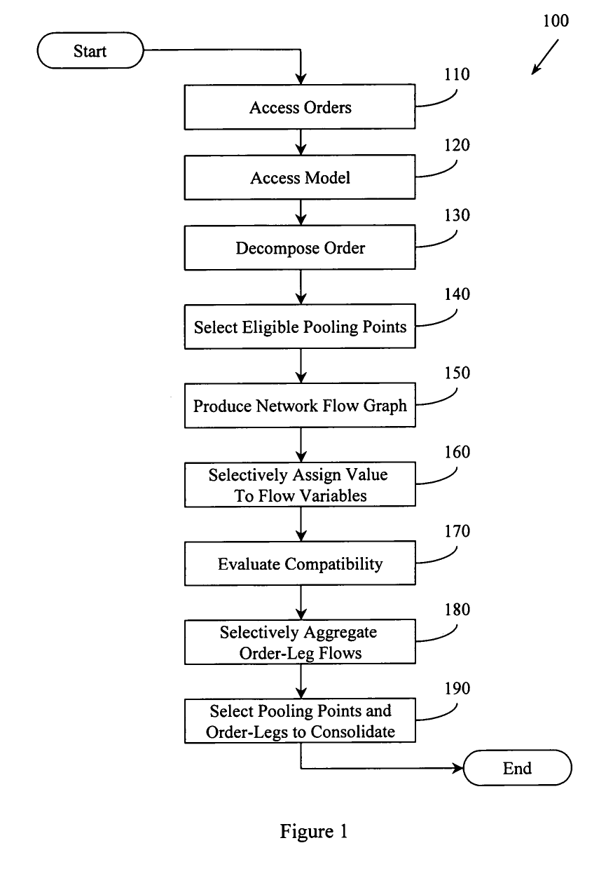

FIG. 1 illustrates an example computer-implemented method 100 that is associated with transportation planning using network flow based multi-level pooling. Multi-level pooling involves routing a shipment through a combination of pooling points that may involve different combinations of consolidation strategies. Multi-level pooling may present computational complexities due to the type and quantity of decisions involved. For example, decisions concerning selection of pooling points, selecting levels or tiers of pooling, selecting orders that may benefit from pooling instead of being sent direct, and so on may need to be made. Conventionally, planners pre-determined pooling points and then considered how to consolidate orders. Pooling points may have been selected by rules of thumb like “all shipments going to Georgia shall be delivered first to a pooling point in Atlanta”. This typically lead to suboptimal loads. These conventional systems typically de-coupled pooling point selection from selecting orders for consolidation. Example systems and methods described herein may couple these decisions.

Method 100 may include, at 110, accessing a set of orders. An order may describe, for example, an item(s) that is to be delivered to a facility. How, when, how much to deliver, and so on may be described by order requirements associated with the order. Order requirements may also include, for example, an earliest time at which the order may be picked up, a latest time at which the order may be picked up, the earliest time at which the order can be delivered, the latest time at which the order can be delivered, a source location for the order, a destination for the order, and so on. Time constraints for an order may be referred to as time windows. Accessing the set of orders may include, for example, receiving orders via computer communications, reading orders stored in a data store, and so on.

Method 100 may also include, at 120, accessing a transportation planning model. The transportation planning model may include, for example, data concerning a transportation network that includes a set of potential pooling points. The transportation planning model may also include compatibility data concerning compatibilities between orders and pooling points. While the transportation model is described including transportation network data and compatibility data, it is to be appreciated that these two types of data may be stored in separate logical and/or physical repositories while conceptually remaining part of the same model.

The transportation planning model may include, for example, information concerning modes by which an order may be shipped like a parcel mode, a less than truckload mode, a truckload mode, and so on. The transportation planning model may also include information concerning carriers by which an order can be delivered to a facility. The carriers may include, for example, parcel carriers, less than truckload carriers, truckload carriers, and so on. The transportation planning model may also include, for example, rates charged by the carriers to carry an item(s) according to the modes, facilities from which items are carried, facilities to which the items are carried, consolidation points through which items may pass and/or be (de)consolidated, cross-docking locations across which items may pass and/or be (de)consolidated, a transportation network (e.g., roads) upon which the carriers travel, and so on. Accessing the transportation planning model may include, for example, receiving the model in a computer communication, reading the model from a data store, connecting to the model in a logic, and so on.

Method 100 may also include, at 130, decomposing an order in the set of orders into order-leg flows. An order-leg flow is a portion (leg) of a path between an order origin and an order destination that can be characterized by information like a start time window for the leg, an end time window for the leg, the amount of a commodity to be transferred on the leg, and so on. The order origin, order destination, leg start window, leg end window, and so on can be modeled as attributes of nodes in the transportation network.

Method 100 may also include, at 140, selecting eligible pooling points from the set of potential pooling points. Determining the eligible pooling points may depend, at least in part, on certain compatibilities. The eligible pooling points may also be selected, at least in part, based on time and scheduling issues. For example, pooling points with capacity available during a time window associated with an order-leg flow may be included for subsequent processing. The pooling points may include, for example, consolidation points, deconsolidation points, cross-docking points, and the like. In one example, the complete set of potential pooling points may be considered for eligibility while in another example less than the complete set may be considered. Furthermore, in one example, some potential pooling points to be considered may be manually pre-selected. Selecting a pooling point may include, for example, adding the pooling point to a data structure, manipulating data associated with the pooling point in a data store, and so on.

Selecting eligible pooling points may affect the flow path for orders. In one example, selection criteria that may control whether a pooling point is eligible may be user configurable. For example, parameters like “serving radius” and “number of pooling points to consider” may be user configurable. By way of illustration, a user may want to constrain method 100 to only select the two nearest pooling points within one hundred miles of the “ship from” location of an order and also to only select the two nearest pooling points within one hundred miles of the order destination. Given user selections for these parameters concerning pooling points, an order may flow through zero, one or two of them while creating the order flow path.

Method 100 may also include, at 150, producing a network flow graph that includes the order-leg flows. Producing a network flow graph may include, for example, identifying potential paths through the transportation network. Clearly the potential paths will include at least the paths associated with the order-leg flows. However, in different examples, the network flow graph may include other potential paths that do not necessarily include paths associated with the order-leg flows. In one example, the network flow graph may include all and/or substantially all possible paths through the transportation network.

Since the origin, destination, and intermediate points including the (de)consolidation points may be treated as nodes in a network flow model, method 100 may also include as part of producing a network flow graph, modeling as a node capacity information like a loading capacity of a pooling point, an unloading capacity of a pooling point, a dock capacity of a pooling point, and the like. While (un)loading capacity, dock capacity, and so on are provided as examples, it is to be appreciated that other characteristics of a pooling point may be modeled.

A network flow graph is well known to those skilled in the art, particularly those familiar with network flow algorithms. Thus, it is to be appreciated that the order-leg flows may be characterized by flow variables. Therefore, method 100 may also include, at 160, selectively assigning a value to the flow variables. In one example the values may be automatically assigned based on data retrieved from the transportation planning model, the compatibility data and/or the set of orders. Additionally, and/or alternatively, values may be manually assigned. The flow variables may be configured to store data like order-leg flow capacity, order-leg flow cost, order-leg flow availability, order-leg flow priority, and so on. While four types of flow variables are described, it is to be appreciated that a greater and/or lesser number of flow variables configured to store different types of data may be employed.

Method 100 may also include, at 170, evaluating various compatibilities between an order-leg flow and a potential pooling point. In one example, the compatibilities may be evaluated by looking at the compatibility data. The compatibility data may concern relationships between, for example, carriers, facilities, commodities, hubs, and so on. In one example, the compatibility data may describe flexible and/or hard constraints describing relationships like facility/vehicle, facility/facility, item/facility, customer/facility, region/facility, and so on. One compatibility concerns order time windows as compared to facility availability times. For example, a pooling point may be excluded from further consideration if it will not be open during a time(s) when the order-leg needs to be processed. Thus, in one example, action 170 may include translating an order time window into flexible time windows for an order leg-flow. This may facilitate selectively aggregating order-leg flows into arc flows at 180 by facilitating identifying order-leg flows having intersecting flexible time windows.

Method 100 may also include, at 180, selectively aggregating order-leg flows into arc flows. Once again, arc flows are known to those skilled in the art of network flow problems. Delving deeper into network flow problems, in one example method 100 may interact with look-ahead heuristics that expect simple consolidation and multi-stop strategies. These consolidation and multi-stop strategies may be anticipated and captured in the forms of constraints and objective values in the network flow problem and thus facilitate providing more optimal solutions.

Method 100 may also include, at 190, selecting final pooling points to use from the previously determined eligible pooling points. At 190, method 100 may also include selecting order-legs to consolidate into consolidated order-legs at various final pooling points. It is to be appreciated that in the context of action 190, consolidating may include deconsolidating and final pooling points may include (de)consolidation and cross-docking points. Note that these two selections may be made substantially simultaneously and in a co-operative basis. Conventionally, these two decisions would be made independently, in serial, with a first decision necessarily constraining the second decision. Here, the two decisions are linked and are made, at least in part, based on a goal of reducing and/or minimizing a transportation cost associated with transporting the orders by selectively routing and/or processing the selected order-legs through the final pooling points.

In one example, determining the transportation cost may include estimating the number of vehicles needed to carry an item included in the arc-flows and evaluating a cost of transporting the item. Then, since a mixed integer network flow model may be employed in some examples, the cost may be posted as an objective value for a network flow cost function. An objective minimum cost function may be configured with constraints like, making sure each order is covered at least once, that a trip may carry a set of order-legs, and that between delivery legs the time windows must be sufficient. In one example, method 100 may examine all permutations of routes through a transportation network. Each order-leg and its associated flow variables may thus be considered and it may be determined that some orders share legs. These shared legs may be considered by the objective minimum cost function.

Method 100 may also include, not illustrated, providing an actionable plan of loads. In one example, the actionable plan of loads may be constructed using a bin-packing heuristic to construct loads based, for example, on the final pooling points and the consolidated order-legs. The actionable plan may be provided, for example, on a computer-readable medium like a disk, a CD, a DVD, and so on. In one example, the actionable plan and/or portions thereof may be distributed to carriers by, for example, the Internet. In this case, the computer-readable medium may take the form of a carrier wave. The loads may be described by data including, for example, a start time, a start location, a sequenced set of stops, and a set of shipments involved in the load. It is to be appreciated that in some examples a load may include multiple stops, that some items may be dropped off at a stop and that other items may be picked up at a stop.

While FIG. 1 illustrates various actions occurring in serial, it is to be appreciated that various actions illustrated in FIG. 1 could occur substantially in parallel. By way of illustration, a first process could access orders and the transportation planning model, a second process could decompose orders, a third process could produce a network flow graph and assign values to flow variables, a fourth process could evaluate compatibilities and determine eligible pooling points, a fifth process could aggregate order-leg flows and a sixth process could collaboratively select pooling points and order legs to consolidate. While six processes are described, it is to be appreciated that a greater and/or lesser number of processes could be employed and that lightweight processes, regular processes, threads, and other approaches could be employed.

In one example, methodologies are implemented as processor executable instructions and/or operations stored on a computer-readable medium. Thus, in one example, a computer-readable medium may store processor executable instructions operable to perform a method that includes accessing a set of orders and a transportation planning model that includes data about a transportation network that includes a set of potential pooling points and a compatibility data concerning compatibilities between orders and pooling points. The method may also include decomposing an order into order-leg flows and selecting eligible pooling points through which an order may pass or at which an order may be processed. The method may also include producing a network flow graph that includes the order-leg flows. The order-leg flows may be characterized by flow variables and thus the method may include selectively assigning a value to the flow variables. The method may also include evaluating a compatibility between an order-leg flow and a potential pooling point based, for example, on the compatibility data. The method may also include selectively aggregating order-leg flows into arc flows. The method may also include selecting final pooling points and order-legs to consolidate with the goal of reducing and/or minimizing a transportation cost associated with transporting the orders by selectively routing and/or processing the selected order-legs through the final pooling points.

While the above method is described being stored on a computer-readable medium, it is to be appreciated that other example methods described herein can also be stored on a computer-readable medium.

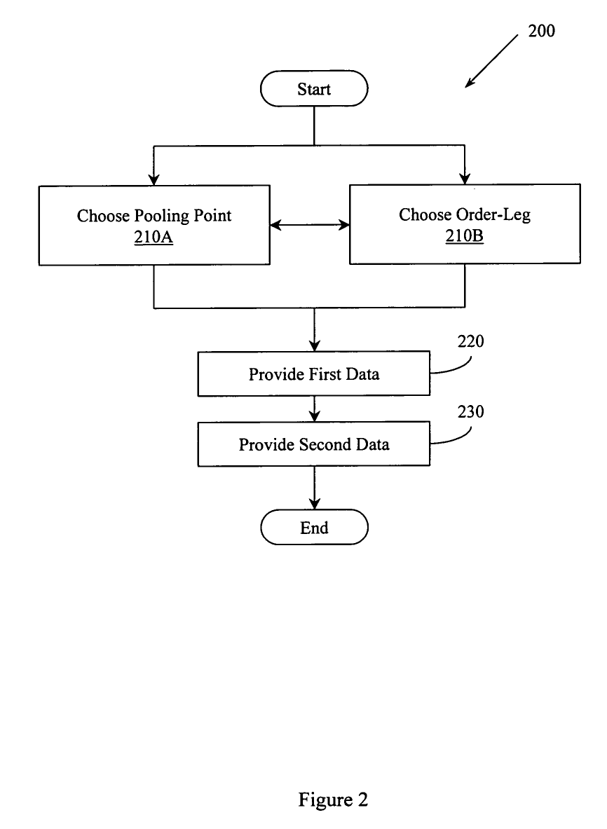

FIG. 2 illustrates a computer-implemented network flow based multi-level pooling transportation planning method 200. Method 200 may include, at 210A, choosing pooling points and at 210B choosing order-legs to consolidate. The choosings may be based, at least in part, on data, functions, and/or values associated with a mixed integer network flow model as applied to a transportation planning environment. Actions 210A and 210B are arranged side by side to illustrate that these two actions may be taken substantially in parallel and may be performed by co-operating processes. Performing co-operating actions 210A and 210B in parallel facilitates exploiting the dependencies of these two types of decisions to find lower cost transportation planning solutions.

In one example, choosing a pooling point at 210A may include accessing a network model, accessing a data concerning pooling points to consider, and accessing a set of orders. With these inputs available, a pooling point may then be chosen by, for example, evaluating a compatibility between an order and a potential pooling point and then computing a transportation cost that would be incurred by processing selected order-legs through the candidate pooling point. Processing the selected order-legs may include, for example, consolidating actions, deconsolidating actions, cross-docking actions, and so on.

In one example, choosing an order-leg to consolidate at 210B may include decomposing orders in the set of orders into order-leg flows. As described above order-leg flows represent a portion of a trip that may satisfy an order and may be described by data associated with the nodes involved and the arc between the nodes. Thus, 210B may also include producing a network flow graph that includes the order-leg flows and selectively aggregating order-leg flows into arc flows. With the arc flows computed, 210B may also include selecting order-legs to consolidate into consolidated order-legs to minimize a transportation cost associated with transporting the consolidated order-legs. The order-legs passing through the candidate pooling points may be subject to actions like consolidation, deconsolidation, cross-docking, and so on, at the pooling points.

Method 200 may also include, at 220, providing a first data concerning a set of order-leg divisions associated with the chosen pooling points. The first data may be provided as an input to a planning engine (not illustrated) that can then build an actionable plan of loads. The first data may depend, at least in part, on modeling non-linear advantages of consolidated order-legs as shipped, for example, by air, parcel mode, less-than-truckload mode, truckload mode, and so on. Thus, the first data may describe, for example, actions to be performed on the selected order-legs at the chosen pooling points. The actions may include, for example, consolidation, deconsolidation, cross-docking, moving from a first carrier to a second carrier, moving from a first carriage mode to a second carriage mode, and so on.

Method 200 may also include, at 230, providing a second data concerning a set of consolidated order-legs. Like the first data, the second data may also be provided as an input to a planning engine (not illustrated) that may then build an actionable plan of loads. Like the first data, the second data may depend, at least in part, on modeling non-linear advantages of consolidated order-legs. The second data may include information like time windows during which an order-leg should be handled, special handling instructions for a commodity associated with an order-leg, order-leg history (e.g., nodes traversed), and so on.

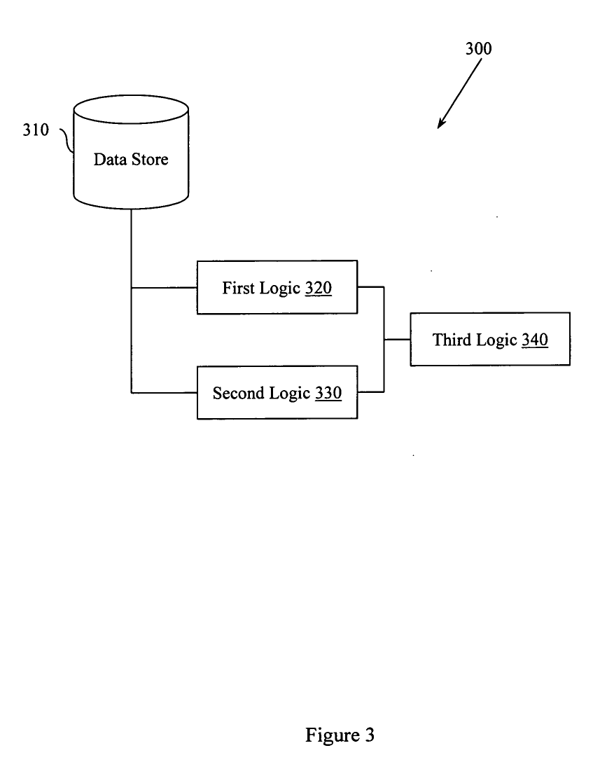

FIG. 3 illustrates a transportation planning system 300 that employs network flow based multi-level pooling. System 300 may include a data store 310 that is configured to store a set of orders, a transportation planning model, and a compatibility data. While a single data store 310 is illustrated, it is to be appreciated that the orders, the transportation planning model and/or the compatibility data may be stored in separate data stores. The transportation planning model may describe, for example, shipping modes, carriers, facilities, a transportation network, constraints associated with carriers, facilities, commodities, and so on. Additionally, the transportation planning model may include data concerning factors relevant to shipping an item from a source to a destination like a transportation network configuration, the capacity of various types of equipment, transit times across portions of the transportation network, commodity to commodity compatibilities, commodity to equipment compatibilities, commodity to facility compatibilities, commodity to carrier compatibilities, facility to equipment compatibilities, rules for carriers, carrier limits, laws concerning hours of service for drivers and/or equipment, days on which a facility may be open, hours during which a facility may operate, the availability of equipment (e.g., tractors, trailers), the availability of drivers, the capacity of a facility, carrier pickup lead times, groups of items that need to be shipped together, and so on. In one example, these factors may be selectively modeled as node capacities associated with nodes in a network flow graph.

System 300 may also include a first logic 320 that is operably connected to data store 310. First logic 320 may be configured to identify a pooling point by taking various actions. For example, first logic 320 may evaluate the compatibility of an order and a pooling point to determine whether the pooling point is a candidate for subsequent selection processing. By way of illustration, if a pooling point is not able to process a certain type of commodity associated with an order-leg, then it should be removed from further consideration. For example, if an order-leg is transporting a commodity like hand grenades that require a threshold level of security and the pooling point does not meet that threshold then it may be excluded from further consideration for participating in handling that order-leg. Additionally, first logic 320 may compute a cost for shipping orders through the candidate pooling points to facilitate identifying pooling points that will lead to reduced and/or minimized transportation costs.

System 300 may also include a second logic 330 that is operably connected to data store 310 and first logic 320. Second logic 330 may be configured to identify order-legs to consolidate into a consolidated order-leg by taking various actions. For example, second logic 330 may decompose orders into order-leg flows. Thus, rather than treating an order as an atomic entity with a single origin and single destination, second logic 330 may view an order as a related set of legs through a flow graph. Thus, second logic 330 may also produce a network flow graph that includes among its nodes the nodes associated with order-leg flows. Having built the network flow graph, second logic 330 may also selectively aggregate order-leg flows into arc flows to facilitate determining which order-legs to consolidate and thus in turn to facilitate planning trips that will satisfy the orders. Second logic 330 may then determine which order-legs to consolidate based on a goal of reducing and/or minimizing a cost for shipping the consolidated order-legs.

System 300 may also include a third logic 340 that is operably connected to first logic 320 and second logic 330. Third logic 340 may be configured to provide an actionable plan of loads that facilitates selectively routing consolidated order-legs through the pooling point and/or processing the order-legs at the pooling point. In one example, third logic 340 may be configured to produce the actionable plan of loads using a bin-packing heuristic. The actionable plan of loads may include data like start times for loads, itineraries for loads, actions to be taken at various stops along the path of a load, and so on.

In one example, first logic 320 and second logic 330 are configured to co-operate and to operate substantially in parallel with each other. For example, first logic 320 and second logic 330 may both access data store 310 and thus may both access order data, transportation network data, and/or compatibility data to make their decisions. Furthermore, information concerning decisions made in first logic 320 may be available to second logic 330 and vice versa. While first logic 320 and second logic 330 are illustrated as separate components, it is to be appreciated that in one example the two logics may be combined into a single logic and that in another example the two logics may be distributed into a greater number of logics.

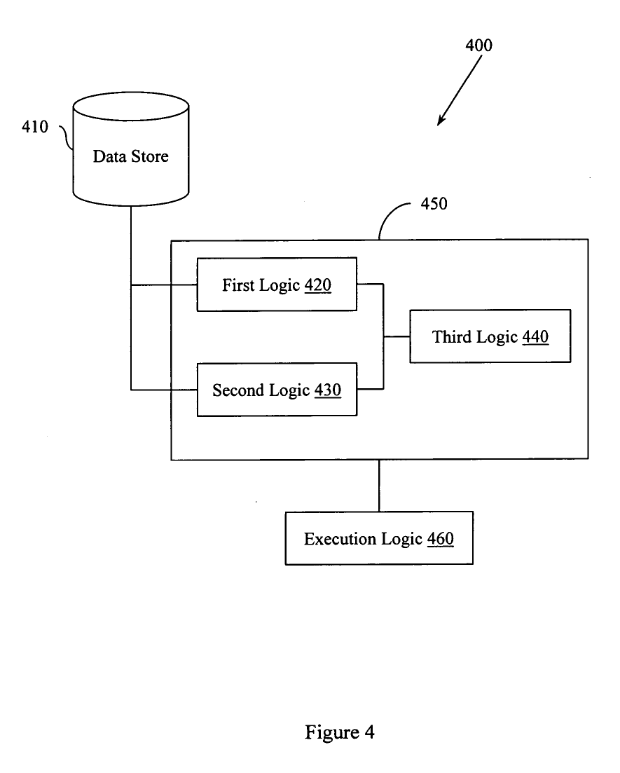

FIG. 4 illustrates a system 400 for transportation planning using network flow based on multi-level pooling. System 400 includes components 410 through 440 that are similar to components 310 through 340 (FIG. 3). In system 400, components 410 through 440 have been aggregated into a planning component 450. Additionally, system 400 includes an execution logic 460. Execution logic 460 may be configured to receive an actionable plan of loads from planning component 450. Execution logic 460 may then interact with carriers and perform tasks like rating, tendering, booking, tracing/tracking, and so on.

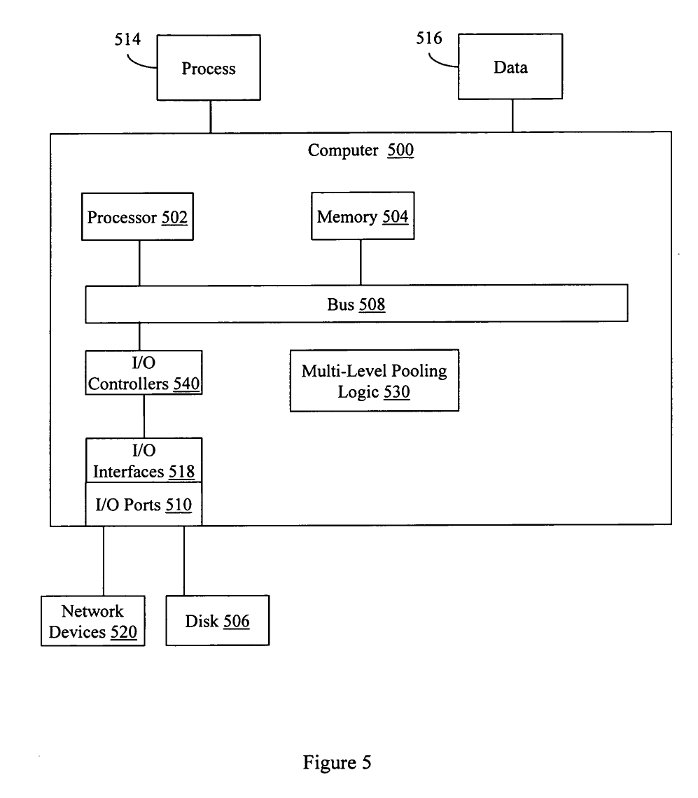

FIG. 5 illustrates an example computing device in which example systems and methods described herein, and equivalents, can operate. The example computing device may be a computer 500 that includes a processor 502, a memory 504, and input/output ports 510 operably connected by a bus 508. In one example, the computer 500 may include a multi-level pooling logic 530 that is configured to facilitate selecting pooling points and order-legs to consolidate. The multi-level pooling logic 530 may implement example systems and methods described herein.

In one example, multi-level pooling logic 530, whether implemented in hardware, software, and/or firmware may provide means (e.g., hardware, software) for automatically choosing a pooling point, means (e.g., hardware, software) for automatically, contemporaneously, and co-operatively choosing one or more order-legs to consolidate, and means (e.g., hardware, software) for determining a cost-optimal trip based on the pooling point and the one or more order-legs. While illustrated as a single logic, it is to be appreciated that logic 530 may be distributed between two or more logics and/or may be replicated in, for example, memory 504, disk 506, and so on.

Generally describing an example configuration of the computer 500, the processor 502 can be a variety of various processors including dual microprocessor and other multi-processor architectures. The memory 504 can include volatile memory and/or non-volatile memory. The non-volatile memory can include, but is not limited to, read only memory (ROM), programmable ROM (PROM), erasable PROM (EPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM).

A disk 506 may be operably connected to the computer 500 via, for example, an input/output interface (e.g., card, device) 518 and an input/output port 510. The disk 506 can include, but is not limited to, devices like a magnetic disk drive, a solid state disk drive, a floppy disk drive, a tape drive, a Zip drive, a flash memory card, and/or a memory stick. Furthermore, the disk 506 can include optical drives like a compact disk ROM (CD-ROM), a CD recordable drive (CD-R drive), a CD rewriteable drive (CD-RW drive), and/or a digital video ROM drive (DVD ROM). The memory 504 can store processes 514 and/or data 516, for example. The disk 506 and/or memory 504 can store an operating system that controls and allocates resources of the computer 500.

The bus 508 can be a single internal bus interconnect architecture and/or other bus or mesh architectures. While a single bus is illustrated, it is to be appreciated that computer 500 may communicate with various devices, logics, and peripherals using other busses that are not illustrated (e.g., PCIE, SATA, Infiniband, 1394, USB, Ethernet). The bus 508 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 500 may interact with input/output devices via input/output (I/O) interfaces 518 and I/O ports 510. I/O devices can include, but are not limited to, a keyboard, a microphone, a pointing and selection device, cameras, video cards, displays, disk 506, network devices 520, and the like. The I/O ports 510 can include but are not limited to, serial ports, parallel ports, and USB ports.

The computer 500 can operate in a network environment and thus may be connected to network devices 520 via the I/O devices 518, and/or the I/O ports 510. Through the network devices 520, the computer 500 may interact with a network. Through the network, the computer 500 may be logically connected to remote computers. The networks with which the computer 500 may interact include, but are not limited to, a local area network (LAN), a wide area network (WAN), and other networks. The network devices 520 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 520 can connect to WAN technologies including, but not limited to, point to point links, circuit switching networks like integrated services digital networks (ISDN), packet switching networks, and digital subscriber lines (DSL).

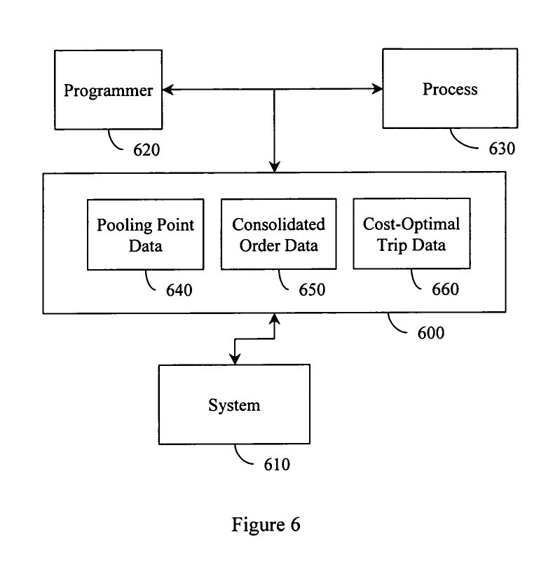

Referring now to FIG. 6, an application programming interface (API) 600 is illustrated providing access to a system 610 that performs transportation planning using a multi-level pooling model. API 600 can be employed, for example, by a programmer 620 and/or a process 630 to gain access to processing performed by system 610. For example, programmer 620 can write a program to access system 610 (e.g., invoke its operation, monitor its operation, control its operation) where writing the program is facilitated by the presence of API 600. Rather than programmer 620 having to understand the internals of system 610, programmer 620 merely has to learn the interface to system 610. This facilitates encapsulating the functionality of system 610 while exposing that functionality.

API 600 can be employed to provide data values to system 610 and/or retrieve data values from system 610. For example, a process 630 that identifies pooling points can provide data to system 610 via API 600 by, for example, using a call provided in API 600. Thus, in one example of API 600, a set of application programming interfaces can be stored on a computer-readable medium. The interfaces can include, but are not limited to, a first interface 640 that communicates a pooling point data including, for example, an ownership data, an hours of operation data, an equipment compatibility data, a capacity data, and so on. The interfaces may also include a second interface 650 that communicates a consolidated order data including, for example, a set of orders, a pickup window, a delivery window, an origin, a destination, and so on. The interfaces may also include a third interface 660 that communicates a cost-optimal trip data including, for example, a start time, a sequence of stops, and so on. In one example, the cost-optimal trip may be computed using the pooling point data and the order data.

FIG. 7 illustrates example consolidation possibilities. Consolidation possibilities may include, for example, simple consolidation 710 where orders with a common source and destination are placed on the same truck. Consolidation possibilities may also include single tier pooling like inbound pooling 720 where orders for a common destination are brought to a consolidation point, consolidated, and sent to the common destination. Consolidation possibilities may also include outbound pooling 730 where orders having a common source but different destinations are sent to a deconsolidation point and then broken down into smaller shipments. Pooling may also include multi-tier pooling 740 and cross-docking 750. In one example, pooling points may be selected by logics operating in parallel based on factors like origin neighborhoods, destination neighborhoods, and so on. In one example, orders may be selected to participate in pooling based on factors like order size, distance from origin to a pooling point, distance from destination to a pooling point, and so on.

FIG. 8 illustrates other load consolidation scenarios. These possibilities include, for example, a multi-stop load 810 and a compound pooling, multi-stop load 820. In 810, a truck may make four stops including a pickup at A, and deliveries at B, C, and D. Additionally, at D, rather than live (un)loading, the trailer may be dropped off and another trailer may be picked up. In 820, a truck may make a pickup at Q, a delivery of a single shipment at R, a delivery of several shipments for several different destinations at deconsolidation point S, and then drop the trailer at T.

By way of illustrating hubbing, consolidation pooling may exploit inbound consolidation advantages by moving smaller shipments to a hub close to the origins of the shipments and forming consolidated line hauls that ship out of the hub. Similarly, deconsolidation pooling may exploit outbound consolidation advantages of moving a consolidated line-haul load that includes many small shipments to a hub and then sending the smaller shipments separately out of the hub to destinations closer to the hub. Cross-docking may exploit both inbound and outbound consolidation advantages at the same hub by moving consolidated shipments from common origins to a hub, disassembling the shipments and reassembling consolidated shipments to common destinations out of the hub.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computer-implemented method for transportation planning using a network flow based multi-level pooling model, the method comprising:
accessing a set of orders;
accessing a transportation planning model comprising:
data concerning a transportation network that includes a set of potential pooling points; and
a compatibility data concerning compatibilities between orders and pooling points;
decomposing an order in the set of orders into one or more order-leg flows;
selecting from the set of potential pooling points one or more eligible pooling points through which an order-leg may pass;
producing a network flow graph that includes the order-leg flows, where the order-leg flows may be characterized by one or more flow variables;
selectively assigning a value to the one or more flow variables;
evaluating a compatibility between an order-leg flow and a potential pooling point based, at least in part, on the compatibility data;
selectively aggregating one or more order-leg flows into one or more arc flows; and
selecting one or more included pooling points from the one or more eligible pooling points and selecting one or more order-legs to consolidate into one or more consolidated order-legs based, at least in part, on minimizing a transportation cost associated with transporting the set of orders.

2. The method of claim 1, where an order includes data concerning one or more of, a commodity to be shipped, an order time window, an earliest pickup time, an earliest delivery time, a latest pickup time, a latest delivery time, a source, and a destination.

3. The method of claim 1, where the transportation planning model includes data concerning one or more of, a carriage mode, a carrier, a carriage rate, and a facility.

4. The method of claim 1, where a potential pooling point may be one or more of, a consolidation point, a deconsolidation point, and a cross-docking point and where one or more pooling point selection criteria parameters are user configurable.

5. The method of claim 1, where the compatibility data includes one or more of, an item to be carried, a pooling point owner, a carrier that can use a pooling point, an item that can use a pooling point, and an equipment that can use a pooling point.

6. The method of claim 1, including:
estimating the number of vehicles needed to carry an item included in the arc-flows;
evaluating a cost of transporting the item; and
posting the cost as an objective value associated with a mixed integer network flow model.

7. The method of claim 2, including translating an order time window into one or more flexible time windows for an order leg-flow.

8. The method of claim 7, where selectively aggregating one or more order-leg flows into one or more arc flows includes identifying one or more order-leg flows having intersecting flexible time windows.

9. The method of claim 1, where producing a network flow graph includes identifying one or more potential paths through the transportation network, the potential paths including at least the paths associated with the order-leg flows.

10. The method of claim 9, including modeling as a node capacity one or more of, a loading capacity of a potential pooling point, an unloading capacity of a potential pooling point, and a dock capacity of a potential pooling point.

11. The method of claim 1, including pre-selecting one or more included pooling points.

12. The method of claim 1, where the one or more flow variables are configured to store data concerning one or more of, an order-leg flow capacity, an order-leg flow cost, an order-leg flow availability, and an order-leg flow priority.

13. The method of claim 1, including producing an actionable plan of loads using a bin-packing heuristic to construct one or more loads based, at least in part, on the included pooling points and the consolidated order-legs.

14. A computer-readable medium storing processor executable instructions operable to perform the method of claim 1.

15. A computer-implemented method for transportation planning using a network flow based multi-level pooling model, the method comprising:
accessing a set of orders, where an order includes data concerning one or more of, a commodity to be shipped, an order time window, an earliest pickup time, an earliest delivery time, a latest pickup time, a latest delivery time, a source, and a destination;
accessing a transportation planning model comprising:
data concerning a transportation network that includes a set of potential pooling points, where a potential pooling point may be one or more of, a consolidation point, a deconsolidation point, and a cross-docking point;
a compatibility data concerning compatibilities between orders and pooling points, where the compatibility data includes one or more of, an item to be carried, a pooling point owner, a carrier that can use a pooling point, an item that can use a pooling point, and an equipment that can use a pooling point; and
data concerning one or more of, a carriage mode, a carrier, a carriage rate, and a facility;
decomposing an order in the set of orders into one or more order-leg flows;
selecting from the set of potential pooling points one or more eligible pooling points through which an order-leg may pass;
producing a network flow graph that includes the order-leg flows, where the order-leg flows may be characterized by one or more flow variables, where producing the network flow graph includes identifying potential paths through the transportation network, the potential paths including at least all the paths associated with the order-leg flows, and where the one or more flow variables are configured to store data concerning one or more of, an order-leg flow capacity, an order-leg flow cost, an order-leg flow availability, and an order-leg flow priority;
selectively assigning a value to the one or more flow variables;
evaluating a compatibility between an order-leg flow and a potential pooling point based, at least in part, on the compatibility data;
translating an order time window into one or more flexible time windows for an order-leg flow;
selectively aggregating one or more order-leg flows into one or more arc flows including identifying one or more order-leg flows having intersecting flexible time windows;
modeling as a node capacity one or more of, a loading capacity of a potential pooling point, an unloading capacity of a potential pooling point, and a dock capacity of a potential pooling point;
estimating the number of vehicles needed to carry an item included in the arc-flows;
evaluating a cost of transporting the item;
posting the cost as an objective value associated with a mixed integer network flow model;
selecting one or more included pooling points from the eligible pooling points and selecting one or more order-legs to consolidate into one or more consolidated order-legs based, at least in part, on minimizing a transportation cost associated with transporting the set of orders; and
producing an actionable plan of loads using a bin-packing heuristic to construct one or more loads based, at least in part, on the included pooling points and the consolidated order-legs.

16. A computer-implemented network flow based multi-level pooling transportation planning method, comprising:
substantially in parallel, co-operatively choosing one or more pooling points and one or more order-legs to consolidate based, at least in part, on a mixed integer network flow model;
providing a first data concerning a set of order-leg divisions associated with the one or more pooling points; and
providing a second data concerning the one or more order-legs to consolidate.

17. The method of claim 16, where choosing a pooling point includes:
accessing a network model;
accessing a data concerning pooling points to consider;
accessing a set of orders;
evaluating a compatibility between an order and a pooling point to identify one or more candidate pooling points; and
computing a transportation cost for routing one or more consolidated order-legs through the one or more candidate pooling points.

18. The method of claim 17, where choosing an order-leg to consolidate includes:
decomposing an order in the set of orders into one or more order-leg flows;
producing a network flow graph that includes the one or more order-leg flows;
selectively aggregating one or more order-leg flows into one or more arc flows; and
selecting one or more order-legs to consolidate into consolidated order-legs based, at least in part, on minimizing a transportation cost associated with transporting the consolidated order-legs through the candidate pooling points.

19. The method of claim 18, including modeling one or more non-linear advantages of the consolidated order-legs, where the consolidated order-legs are shipped by one or more of, an air mode, a parcel mode, a less-than-truckload mode, and a truckload mode.

20. A network flow based multi-level pooling transportation planning system, comprising:
a data store configured to store a set of orders, a transportation model, and a compatibility data;
a first logic operably connected to the data store, the first logic being configured to identify a pooling point;
a second logic operably connected to the data store and the first logic, the second logic being configured to identify one or more order-legs to consolidate into a consolidated order-leg; and
a third logic operably connected to the first logic and the second logic, the third logic being configured to provide an actionable plan of loads that selectively routes consolidated order-legs through the pooling point;
the first logic and the second logic being configured to operate substantially in parallel with each other and to co-operate with each other in identifying the pooling point and the one or more order-legs to consolidate.

21. The system of claim 20, the first logic being configured to identify a pooling point by:
evaluating a compatibility between one or more orders and one or more pooling points to identify one or more candidate pooling points; and
computing a cost for shipping the one or more orders through the one or more candidate pooling points.

22. The system of claim 21, the second logic being configured to identify order-legs to consolidate by:
decomposing one or more orders into one or more order-leg flows;
producing a network flow graph that includes the nodes associated with one or more order-leg flows;
selectively aggregating two or more order-leg flows into one or more arc flows; and
selecting one or more order-legs to consolidate based, at least in part, on minimizing a cost for shipping the consolidated order-leg.

23. The system of claim 22, the third logic being configured to produce the actionable plan of loads using a bin-packing heuristic.

24. The system of claim 23, including an execution logic configured to interact with one or more carriers.

25. A system, comprising:
means for automatically choosing a pooling point;
means for automatically, contemporaneously, and co-operatively choosing one or more order-legs to consolidate; and
means for determining a cost-optimal trip based on the pooling point and the one or more order-legs.

26. A set of application programming interfaces embodied on a computer-readable medium for execution by a computer component in conjunction with multi-level pooling transportation planning based on a network flow model, comprising:
a first interface for communicating a pooling point data;
a second interface for communicating a consolidated order data; and
a third interface for communicating a cost-optimal trip data, where the cost-optimal trip is computed from the pooling point data and the order data.
